(19) United States
(12) Patent Application Publication
(10) Pub. No.: US 2018/0205976 A1
(43) Pub. Date: Jul. 19, 2018

(54) METHOD AND APPARATUS OF OBTAINING VIDEO FRAGMENT

(71) Applicant: Huawei Technologies Co., Ltd., Shenzhen (CN)

(72) Inventor: Chuansong XUE, Nanjing (CN)

(21) Appl. No.: 15/925,487

(22) Filed: Mar. 19, 2018

Related U.S. Application Data
(63) Continuation of application No. PCT/CN2016/090067, filed on Jul. 14, 2016.

(30) Foreign Application Priority Data
Sep. 30, 2015 (CN) 201510644214.7

(51) Int. Cl. H04N 21/231; H04N 21/24; H04N 21/845

(52) U.S. Cl. CPC H04N 21/23106; H04N 21/2401; H04N 21/258; H04N 21/8455; H04N 21/2402

(57) ABSTRACT

The invention relates to the field of information technologies, and discloses a terminal, a cache server, and method and apparatus for obtaining a video fragment, so as to reduce a delay of playing a video fragment. The method includes: in response to a trigger condition for obtaining a video fragment, determining that a video fragment needing to be obtained by a terminal is a numbered video fragment of a video file, obtaining video index information of the video file from a cache server, determining a download address of the numbered video fragment according to a download rate of the terminal and the video index information, sending a request message for obtaining a numbered video fragment to the cache server, where the request message for obtaining a video fragment includes the download address of the numbered video fragment and receiving the numbered video fragment returned by the cache server.

### CROSS-REFERENCE TO RELATED APPLICATIONS

This application is a continuation of International Application No. PCT/CN2016/090067, filed on Jul. 14, 2016, which claims priority to Chinese Patent Application No. 201510644214.7, filed on Sep. 30, 2015, the disclosures of which are incorporated herein by reference.

### TECHNICAL FIELD

The invention relates to the field of information technologies, and in particular, to method and apparatus of obtaining a video fragment.

### BACKGROUND

The Hypertext Transfer Protocol streaming (HTTP Streaming) protocol is a streaming media transfer protocol based on the Hypertext Transfer Protocol. The HTTP

Streaming protocol features in fragmenting a video file for storage, and generating video index information and video fragments, to facilitate smooth playing of the video file. The video index information includes master file information and sub-file information. The master file information includes download addresses of the sub-file information corresponding to the video file at different bit rates. Each of the sub-file information includes download addresses of different video fragments of the video file at a particular bit rate.

Currently, to obtain a video fragment, a terminal first obtains a uniform resource locator (URL) for a user to select a video file on a portal site, and sends content service request information carrying the URL to a scheduling server on a content delivery network (CDN), so that the scheduling server selects a suitable cache server and sends a URL corresponding to address information of the cache server to the terminal. Then, the terminal sends request information for obtaining master file information corresponding to the video file to the cache server according to the URL corresponding to the address information of the cache server, so that the cache server obtains the master file information from a source site. The cache server obtains the master file information from the source site and sends the master file information to the terminal. The terminal obtains a download address of each piece of sub-file information corresponding to the video file by using the master file information, determines, from the master file information according to a download rate of the terminal, a download address of sub-file information corresponding to a bit rate lower than the download rate of the terminal, and sends, to the cache server, request information for requesting the sub-file information. Next, the cache server obtains, from the source site, the sub-file information corresponding to the bit rate, and sends the sub-file information to the terminal, so that the terminal obtains a download address of a video fragment corresponding to the bit rate. Finally, the terminal sends a request message for obtaining the video fragment to the cache server, so that the cache server obtains the video fragment from the source site and sends the video fragment to the terminal.

In the above-discussed method, when a video fragment is obtained, the terminal requests the video fragment from the cache server. However, because the cache server may not store the video fragment, the cache server needs to request and obtain the video fragment from a source site, and then sends the obtained video fragment to the terminal. As a result, time for obtaining the video fragment by the terminal increases, leading to a relatively long delay of playing the video fragment on the terminal.

### SUMMARY

Aspects of the invention provide method and apparatus of obtaining a terminal, a cache server, and a video fragment to reduce a delay of playing a video fragment on a terminal.

A first aspect of the invention provides a method of obtaining a video fragment, where the method is used by a terminal to obtain a video fragment of a video file. The method determines, according to a trigger condition for obtaining a video fragment, that a video fragment needing to be obtained by the terminal is an N^{th} (or numbered) video fragment of the video file, where N is a positive integer. The method obtains video index information of the video file from a cache server. The video index information includes sub-file information corresponding to at least two bit rates, and sub-file information corresponding to each bit rate that includes download addresses of different video fragments and corresponding priority information. The method determines a download address of the N^{th} video fragment according to a download rate of the terminal and the video index information. The method sends a request message for obtaining a video fragment to the cache server, where the request message for obtaining a video fragment includes the download address of the N^{th} video fragment. The method receives the N^{th} video fragment returned by the cache server.

In one aspect of the invention, the trigger condition is bit rate conversion information entered by a user is received, information indicating that frame freezing occurs in playing of the video file is received, or a touch operation of a user is received, where the touch operation includes a dragging operation.

In another aspect of the invention, the priority information is used to represent a probability that a video fragment stored on the cache server has been eliminated.

In yet another aspect of the invention, the priority information includes popularity information, and higher-popularity information that represents a smaller probability that a video fragment is stored on the cache server and corresponds to the popularity information has been eliminated.

In still another aspect of the invention, when the popularity information is 0 or null, it represents that the cache server stores no video fragment corresponding to the popularity information.

In another aspect of the invention, in determining a download address of the N^{th} video fragment according to a download rate of the terminal and the video index information, the method determines, according to the download rate of the terminal, sub-file information corresponding to a bit rate satisfying the download rate of the terminal, and obtains, from the sub-file information corresponding to the bit rate satisfying the download rate of the terminal, a download address of an N^{th} video fragment in sub-file information that corresponds to the bit rate and in which the N^{th} video fragment has highest-popularity information; or the method determines, according to the download rate of the terminal, that sub-file information corresponding to a bit rate satisfying the download rate of the terminal does not exist, and obtains, from the video index information, a download address of an N^{th} video fragment in sub-file information corresponding to a lowest bit rate.

A second aspect of the invention provides another method of obtaining video fragment, where the method is applied to a cache server. The method obtains video index information of a video file from a source site and saving the video index information. The method monitors a quantity of times that each video fragment of the video file is requested to obtain priority information of each video fragment of the video file. The method periodically obtains the priority information corresponding to each video fragment of the video file, and adds the obtained priority information corresponding to each video fragment of the video file to the video index information. The method receives a request, sent by a terminal, for obtaining the video index information. The method sends the video index information to the terminal, so that the terminal determines, according to the video index information, a download address of a video fragment needing to be downloaded.

In one aspect of the invention, the priority information of the video fragment is a quantity of times that the video fragment is requested or obtained through conversion according to a preset rule and the quantity of times that the video fragment is requested.

In another aspect of the invention, prior to adding the obtained priority information corresponding to each video fragment of the video file to the video index information, the method determines whether each video fragment of the video file is locally cached. The method further adds the priority information corresponding to each video fragment of the video file to the video index information when the video fragment is locally cached, adding the obtained priority information corresponding to the video fragment to the video index information; or when the video fragment is not locally cached, setting the obtained priority information corresponding to the video fragment to 0 or null, and adding the obtained priority information to the video index information.

A third aspect of the invention provides an apparatus for obtaining a video fragment, where the apparatus is located in a terminal. The apparatus includes: a determining unit, configured to determine, according to a trigger condition for obtaining a video fragment, that a video fragment needing to be obtained by the terminal is an N^{th} video fragment of a video file, where N is a positive integer; an obtaining unit, configured to obtain video index information of the video file from a cache server, where the video index information includes sub-file information corresponding to at least two bit rates, and sub-file information corresponding to each bit rate includes download addresses of different video fragments and corresponding priority information, where the determining unit is further configured to determine a download address of the N^{th} video fragment according to a download rate of the terminal and the video index information that is obtained by the obtaining unit; a sending unit, configured to send a request message for obtaining a video fragment to the cache server, where the request message for obtaining a video fragment includes the download address of the N^{th} video fragment determined by the determining unit; and a receiving unit, configured to receive the N^{th} video fragment returned by the cache server.

In one aspect of the invention, the trigger condition is bit rate conversion information entered by a user is received, information indicating that frame freezing occurs in playing of the video file is received, or a touch operation of a user is received, where the touch operation includes a dragging operation.

In another aspect of the invention, the priority information includes popularity information, and higher-popularity information represents a smaller probability that a video fragment that is stored on the cache server and corresponds to the popularity information has been eliminated.

In yet another aspect of the invention, when the popularity information is 0 or null, it represents that the cache server stores no video fragment corresponding to the popularity information.

In still another aspect of the invention, the determining unit includes a determining module and an obtaining module, where the determining module is configured to determine, according to the download rate of the terminal, sub-file information corresponding to a bit rate satisfying the download rate of the terminal, and the obtaining module is configured to obtain, from the sub-file information that corresponds to the bit rate satisfying the download rate of the terminal and that is determined by the determining module, a download address of an N^{th} video fragment in sub-file information that corresponds to the bit rate and in which the N^{th} video fragment has highest-popularity information; or the determining module is further configured to determine, according to the download rate of the terminal, that sub-file information corresponding to a bit rate satisfying the download rate of the terminal does not exist, and the obtaining module is further configured to obtain, from the video index information, a download address of an N^{th} video fragment in sub-file information corresponding to a lowest bit rate.

A fourth aspect of the invention provides another apparatus for obtaining a video fragment, where the apparatus is located in a cache server. The apparatus includes an obtaining unit configured to obtain video index information of a video file from a source site; a saving unit, configured to save the video index information of the video file; a monitoring unit, configured to monitor a quantity of times that each video fragment of the video file is requested, to obtain priority information of each video fragment of the video file, where the obtaining unit is further configured to periodically obtain the priority information corresponding to each video fragment of the video file; an adding unit, configured to add the priority information that is obtained by the obtaining unit and corresponds to each video fragment of the video file to the video index information; a receiving unit, configured to receive a request, sent by a terminal, for obtaining the video index information; and a sending unit, configured to send the video index information to the terminal, so that the terminal determines, according to the video index information, a download address of a video fragment needing to be downloaded.

In one aspect of the invention, the priority information of the video fragment is a quantity of times that the video fragment is requested or obtained through conversion according to a preset rule and the quantity of times that the video fragment is requested.

In another aspect of the invention, the apparatus further includes a determining unit, where the determining unit is configured to determine whether each video fragment of the video file is locally cached, and the adding unit is specifically configured to: when the determining unit determines that the video fragment is locally cached, add the obtained priority information corresponding to the video fragment to the video index information; or when the determining unit determines that the video fragment is not locally cached, set the obtained priority information corresponding to the video fragment to 0 or null, and add the obtained priority information to the video index information.

A fifth aspect of the invention provides a terminal for obtaining a video fragment. The terminal includes: a memory, configured to store computer executable program code; and a transceiver, and a processor coupled to the memory and the transceiver, where the program code includes instructions, and the processor executes the instructions, to instruct a network element to perform the following operations: determining, according to a trigger condition for obtaining a video fragment, that a video fragment needing to be obtained by the terminal is an N^{th} video fragment of a video file, where N is a positive integer; obtaining video index information of the video file from a cache server, where the video index information includes sub-file information corresponding to at least two bit rates, and sub-file information corresponding to each bit rate includes download addresses of different video fragments and corresponding priority information; determining a download address of the N^{th} video fragment according to a download rate of the terminal and the video index information; sending a request message for obtaining a video fragment to the cache server, where the request message for obtaining a video fragment includes the download address of the N^{th} video fragment; and receiving the N^{th} video fragment returned by the cache server.

A sixth aspect of the invention provides a cache server. The cache server includes: a memory, configured to store computer executable program code; and a transceiver, and a processor coupled to the memory and the transceiver, where the program code includes instructions, and the processor executes the instructions, to instruct a network element to perform the following operations: obtaining video index information of a video file from a source site and saving the video index information; monitoring a quantity of times that each video fragment of the video file is requested, to obtain priority information of each video fragment of the video file; periodically obtaining the priority information corresponding to each video fragment of the video file, and adding the obtained priority information corresponding to each video fragment of the video file to the video index information; receiving a request, sent by a terminal, for obtaining the video index information; and sending the video index information to the terminal, so that the terminal determines, according to the video index information, a download address of a video fragment needing to be downloaded.

Compared with the prior art in which to-be-played video fragment is obtained, according to the terminal and the video fragment obtaining method that are provided in the embodiments of the present invention, when the terminal needs to obtain an N^{th} video fragment of a video file, the terminal determines, as a request address according to priority information of N^{th} video fragments at different bit rates in video index information and a download rate of the terminal, a download address of an N^{th} video fragment that corresponds to highest-priority information and is at a bit rate satisfying the download rate of the terminal, to obtain the video fragment. According to the solutions provided in the present invention, a probability that a cache server obtains a video fragment from a source site can be reduced, thereby reducing a time for obtaining a video fragment by a terminal, and further reducing a delay of playing the video fragment on the terminal.

Compared with the prior art in which to-be-played video fragment information is obtained, in the present invention, the cache server monitors a quantity of times that each video fragment of the video file is requested, to obtain priority information of each video fragment; adds the priority information of each video fragment to the video index information, so that the terminal can determine, according to the priority information of the video fragment in the video index information, a probability that each video fragment is stored on the cache server, and preferably select a video fragment that is quite possibly locally cached on the cache server. This reduces a probability that the cache server obtains a video fragment from a source site, thereby reducing a time for obtaining a video fragment by the terminal, and further reducing a delay of playing the video fragment.

### BRIEF DESCRIPTION OF DRAWINGS

To describe the technical solutions in the invention or in the prior art more clearly, the following briefly describes the accompanying drawings required for describing the invention or the prior art. Apparently, the accompanying drawings in the following description show merely some embodiments of the invention, and a person of ordinary skill in the art may still derive other drawings from these accompanying drawings without creative efforts.

FIG. 1 is a network architecture diagram of a content delivery network.

FIG. 2 is a flowchart of a method of obtaining a video fragment according to an embodiment of the invention.

FIG. 3 is a flowchart of another method of obtaining a video fragment according to an embodiment of the invention.

FIG. 4 is a flowchart of still another method of obtaining a video fragment according to an embodiment of the invention.

FIG. 5 is a flowchart of still another method of obtaining a video fragment according to an embodiment of the invention.

FIG. 6 is a schematic structural diagram of an apparatus for obtaining a video fragment according to an embodiment of the invention.

FIG. 7 is a schematic structural diagram of another apparatus for obtaining a video fragment according to an embodiment of the invention.

FIG. 8 is a schematic structural diagram of still another apparatus for obtaining a video fragment according to an embodiment of the invention.

FIG. 9 is a schematic structural diagram of a terminal for obtaining a video fragment according to an embodiment of the invention.

FIG. 10 is a schematic structural diagram of a cache server according to an embodiment of the invention.

### DESCRIPTION OF EMBODIMENTS

The following clearly describes the technical solutions in the embodiments of the invention with reference to the accompanying drawings in the embodiments of the invention. Apparently, the described embodiments are merely some but not all of the embodiments of the invention. All other embodiments obtained by a person of ordinary skill in the art based on the embodiments of the invention without creative efforts shall fall within the protection scope of the invention.

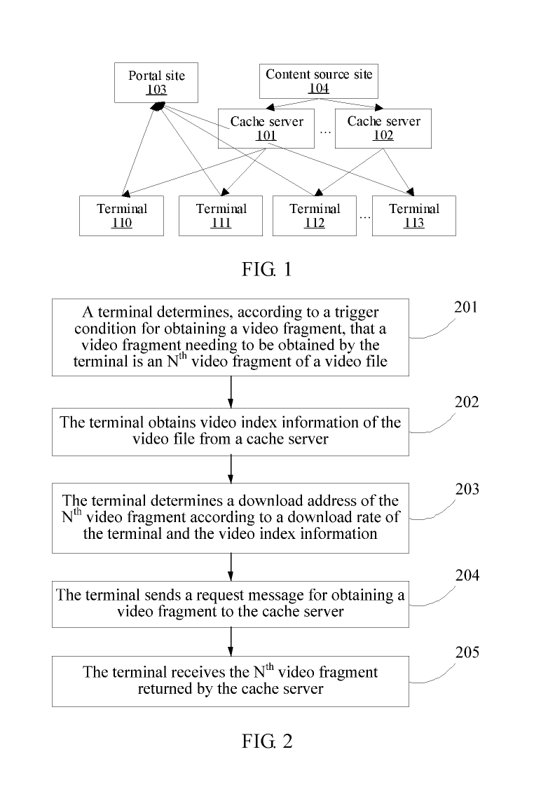

The embodiments of the invention provide a system architecture for obtaining a video fragment. Referring to FIG. 1, the system includes one or more cache servers 101-102, a content source site 104, and one or more terminals 110-113. Optionally, a portal site 103 is further included. As shown in FIG. 1, communication connections exist between the terminals 110-113 and the cache servers 101-102, between the cache servers 101-102 and the source site 104, and between the portal site 103 and the terminals 110-113. In some embodiments, terminals 110-113 may be a personal computer (e.g., desktops, laptops, and tablets), a “thin” client, a personal digital assistant (PDA), a Web enabled appliance, or a mobile phone (e.g.,

Smartphone), etc. In some embodiments, cache servers 101-102 may include or represent any type of servers or a cluster of one or more servers.

In some embodiments, a terminal (e.g., one of the terminals 110-113) accesses a portal site (e.g., portal site 103) of a company (e.g., Sohu), clicks a link to a television sitcom (e.g., Friends) for playing, and determines that a first video fragment of Friends needs to be obtained. The terminal requests master file information of a video file corresponding to Friends from a cache server (e.g., cache servers 101-102). If the master file information corresponding to Friends is stored on the cache server, the cache server directly returns the master file information of the video file. If the master file information corresponding to Friends is not stored on the cache server, the cache server obtains the master file information of the video file from a source site (e.g., content source site 104) and sends the master file information of the video file to the terminal. The terminal parses the master file information to obtain download addresses of all sub-file information, and sends a request message carrying all the sub-file download addresses to the cache server. The cache server obtains all the sub-file information of the video file, and sends the sub-file information to the terminal.

The terminal selects, from all the sub-file information of the video file according to a download rate of the terminal, a download address of the first video fragment, needing to be obtained of Friends, and sends a request message carrying the download address to the cache server. The cache server detects whether the video fragment is locally stored and returns the video fragment to the terminal if the video fragment is locally stored. If the video fragment is not locally stored, the cache server obtains the video fragment from the source site and sends the video fragment to the terminal.

An embodiment of the invention provides a method of obtaining a video fragment, so as to reduce a delay of obtaining a video fragment by a terminal (e.g., terminals 110-113). As shown in FIG. 2, the method includes the following steps.

At 201, the terminal determines, according to a trigger condition for obtaining a video fragment, that a video fragment needs to be obtained by the terminal is an N^{th} (or numbered) video fragment of a video file, where N is a positive integer.

In one embodiment, during practical networking, to meet requirements of the terminal for different download rates, each video file has versions corresponding to different bit rates on a source site (e.g., content source site 104). In this embodiment, each video file is divided into multiple video fragments for storage.

In one embodiment, each video file may be fragmented in the unit of 10 seconds (s), and each video file has versions corresponding to different bit rates. Therefore, each video fragment of the video file has versions corresponding to different bit rates.

For example, as shown in Table 1 herein below, for a 30s video file, 0 to 10s may be the first video fragment, 10s to 20s may be the second video fragment, and 20s to 30s may be the third video fragment. In addition, bit rates corresponding to the first video fragment, the second video fragment, and the third video fragment may include: 1000 kbps, 1500 kbps, and 2000 kbps, or any suitable bit rates.

TABLE 1
Video fragments at different bit rates of a video file

| | Video fragment | | |
|---|---|---|---|
| | First video | Second video | Third video |
| Bit rate | fragment | fragment | fragment |
| 1000 kbps | 0 to 10 s | 10 s to 20 s | 20 s to 30 s |
| 1500 kbps | 0 to 10 s | 10 s to 20 s | 20 s to 30 s |
| 2000 kbps | 0 to 10 s | 10 s to 20 s | 20 s to 30 s |

In one embodiment, the trigger condition may be when bit rate conversion information entered by a user is received, information indicating that frame freezing occurs in playing of the video file is received, or a touch operation of a user is received. In one embodiment, the touch operation may include a dragging operation.

In one embodiment, when the terminal receives the bit rate conversion information entered by the user, for example, converting a top-speed version into a high-definition version, the terminal determines which video fragment of the video file is the video fragment currently that needs to be obtained by the user. For example, when the terminal receives the bit rate conversion information entered by the user, if the terminal is to play a frame at the 15^{th} second (s) of the video file, the terminal needs to obtain the second video fragment of the video file.

In one embodiment, when the terminal detects that frame freezing occurs in playing of a video file, the terminal needs to determine a subsequent (or to-be-played) video fragment. For example, if the terminal detects that frame freezing occurs at the 15^{th} second of the video file, the terminal determines that the video fragment that needs to be obtained is the second video fragment of the video file.

In one embodiment, when the terminal receives the dragging operation of the user, the terminal needs to determine a location obtained after the dragging operation in order to determine a subsequent (or to-be-played) video fragment. For example, the location obtained after the dragging operation of the user is at the 15^{th} second of the video file, the terminal determines that the video fragment that needs to be obtained by the terminal is the second video fragment of the video file.

At 202, the terminal obtains video index information of the video file from a cache server (e.g., cache servers 101-102). In one embodiment, the video index information includes sub-file information corresponding to at least two bit rates, and sub-file information corresponding to each bit rate includes download addresses of different video fragments and corresponding priority information.

In one embodiment, the priority information is used to represent a probability that a video fragment stored on the cache server is or has been eliminated. Higher-priority information represents a smaller probability that a video fragment stored on the cache server is or has been eliminated, and lower-priority information represents a larger probability that a video fragment stored on the cache server is or has been eliminated.

Optionally, in one embodiment the priority information includes popularity information. Higher-popularity information represents a smaller probability that a video fragment that is stored on the cache server and corresponds to the popularity information is or has been eliminated. In this embodiment, when the popularity information is 0 or null, it represents that the cache server stores no video fragment corresponding to the popularity information.

In one embodiment, each video file has one piece of corresponding video index information, and the cache server obtains the video index information corresponding to the video file from the source site on which the video file is stored, and locally saves the video index information. In one embodiment, the video index information includes sub-file information corresponding to at least two bit rates, and sub-file information corresponding to each bit rate includes download addresses of different video fragments at the bit rate and corresponding priority information.

In one embodiment, the terminal first obtains, from the cache server, master file information corresponding to the video fragment that needs to be obtained, and obtains, from the master file information, download addresses of sub-file information corresponding to video fragments at all bit rates. Subsequently the terminal obtains, from the cache server according to the download addresses, the sub-file information of the video fragments at all the bit rates. Specifically, the video index information obtained by the terminal may be as follows:

```
        http://youku/test1000.m3u8//sub-file information corresponding to a bit rate 1000
kbps
        #EXTM3U
        #EXT-X-TARGETDURATION:2
        #EXT-X-MEDIA-SEQUENCE:0
        #EXTINF:2,
        http://youku/test1000/0.ts/100//download address of the first video fragment
                                //http://youku/test1000/0.ts, priority information is
100
        #EXTINF:2,
        http://youku/test1000/1.ts/200//download address of the second video fragment
                                //http://youku/test1000/1.ts, priority information is
200
        #EXTINF:2,
        http://youku/test1000/2.ts//download address of the third video fragment
                            //http://youku/test1000/2.ts, priority information is null
                            //indicating that the cache server does not locally cache the
video fragment
        #EXTINF:2,
        #EXT-X-ENDLIST
        http://youku/test1500.m3u8//sub-file information corresponding to a bit rate 1500
kbps
        #EXTM3U
        #EXT-X-TARGETDURATION:2
        #EXT-X-MEDIA-SEQUENCE: 0
        #EXTINF:2,
        http://youku/test2000/0.ts/100//download address of the first video fragment
                                //http://youku/test1500/0.ts, priority information is
100
        #EXTINF:2,
        http://youku/test1500/1.ts/150//download address of the second video fragment
                                //http://youku/test1500/1.ts, priority information is
150
        #EXTINF:2,
        http://youku/test1500/2.ts/20//download address of the third video fragment
                                //http://youku/test1500/2.ts, priority information is 20
        #EXTINF:2,
        #EXT-X-ENDLIST
        http://youku/test2000.m3u8//sub-file information corresponding to a bit rate 2000
kbps
        #EXTM3U
        #EXT-X-TARGETDURATION:2
        #EXT-X-MEDIA-SEQUENCE:0
        #EXTINF:2,
        http://youku/test2000/0.ts/30//download address of the first video fragment
                              //http://youku/test2000/0.ts, priority information is 30
        #EXTINF:2,
        http://youku/test1500/1.ts/50//download address of the second video fragment
                              //http://youku/test1500/1.ts, priority information is 50
        #EXTINF:2,
        http://youku/test1500/2.ts/10//download address of the third video fragment
                                //http://youku/test1500/2.ts, priority information is 10
        #EXTINF:2,
        #EXT-X-ENDLIST
```

At 203, the terminal determines a download address of the N^{th} video fragment according to a download rate of the terminal and the video index information, where N is a positive integer.

In one embodiment, the download rate of the terminal includes a historical download rate of the terminal or a current download rate of the terminal.

In one embodiment, because each video file has at least two versions corresponding to different bit rates, each video fragment of the video file includes at least two versions corresponding to the different bit rates. Therefore, the terminal first determines, according to the download rate, a bit rate of a video fragment that satisfies the download rate. Then, if there are two or more video fragments satisfying the download rate, the terminal determines, according to priority information of a video fragment at each bit rate, a video fragment that corresponds to higher-priority information and is at the bit rate, and obtains a download address of the video fragment at the bit rate from sub-file information corresponding to the video fragment. Using step 201 and step 202 as an example, the terminal needs to obtain the second video fragment. Priority information of the second video fragment of a version corresponding to the bit rate 1000 kbps is 200 for example, priority information of the second video fragment of a version corresponding to the bit rate 1500 kbps is 150 for example, and priority information of the second video fragment of a version corresponding to the bit rate 2000 kbps is 50 for example. Assuming that a current download rate of the terminal is 1600 kbps in some embodiments, the terminal determines that the video fragments at the bit rate 1000 kbps and bit rate 1500 kbps satisfy the current download rate of the terminal. Further, because the second video fragment at the bit rate 1000 kbps corresponds to a highest priority, the terminal determines that the download address of the second video fragment at the bit rate 1000 kbps, that is for example, http://youku/test1000/1.ts, is a download address of the video fragment needing to be obtained by the terminal.

At 204, the terminal sends a request message for obtaining a video fragment to the cache server. The request message for obtaining a video fragment includes the download address of the N^{th} video fragment.

In one embodiment, after determining the video fragment that needs to be obtained, the terminal obtains a download address of the video fragment from sub-file information corresponding to the video fragment, and sends the download address corresponding to the needed video fragment to the cache server by using the request message. For example, if the download address of the video fragment that needs to be obtained by the terminal is http://youku/test1000/1.ts, the terminal sends a video fragment request message carrying the download address http://youku/test1000/1.ts to the cache server.

At 205, the terminal receives the N^{th} video fragment returned by the cache server. In one embodiment, after requesting the video fragment from the cache server, the terminal receives the video fragment subsequently returned by the cache server.

According to the method of obtaining a video fragment provided, in some embodiments a video fragment that needs to be obtained by a terminal (such as an N^{th} video fragment of a video file) is first determined according to a trigger condition for obtaining a video fragment. Compared with the conventional method in which a video fragment is obtained, in this embodiment, when the terminal needs to obtain the N^{th} video fragment of the video file, the terminal determines, as a request address according to priority information of N^{th} video fragments at different bit rates in video index information and a download rate of the terminal, a download address of an N^{th} video fragment that corresponds to highest-priority information and is at a bit rate satisfying the download rate of the terminal, to obtain the video fragment. According to the solution provided in the invention, a probability of an upstream operation of a cache server can be reduced, thereby reducing a time for obtaining a video fragment by a terminal, and further reducing a delay of playing the video fragment on the terminal.

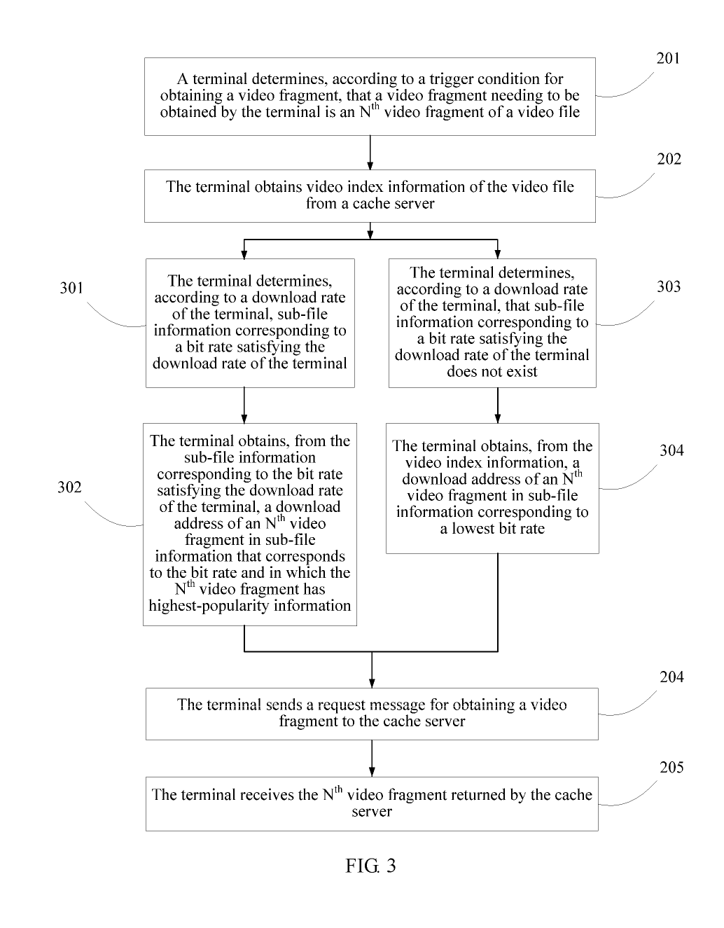

In some embodiments, based on the implementation as shown in FIG. 2, step 203 where the terminal determines a download address of the N^{th} video fragment according to a download rate of the terminal and the video index information may further include step 301 to step 304 shown in FIG. 3.

In more detail, at 301 the terminal determines, according to the download rate of the terminal, sub-file information corresponding to a bit rate that satisfies the download rate of the terminal. In one embodiment, the terminal determines, according to the download rate of the terminal, that a bit rate corresponding to the video fragment that needs to be obtained is less than or equal to the download rate of the terminal.

For example, if a current download rate of the terminal is 1600 bit rate (kbps), and the video fragment that needs to be obtained by the terminal has versions corresponding to three bit rates, namely 1000 kbps, 1500 kbps, and 2000 kbps, bit rates of video fragments satisfying the download rate of the terminal respectively are 1000 kbps and 1500 kbps.

At 302, the terminal obtains, from the sub-file information corresponding to the bit rate that satisfies the download rate of the terminal, a download address of an N^{th} video fragment in sub-file information that corresponds to the bit rate and in which the N^{th} video fragment has highest-popularity information, where N is a positive integer.

In one embodiment, the terminal first determines a bit rate corresponding to a video fragment satisfying the download rate of the terminal, and then obtains, from sub-file information corresponding to the bit rate, popularity information corresponding to the N^{th} video fragment, to obtain a download address of the N^{th} video fragment in sub-file information that corresponds to the bit rate and in which the N^{th} video fragment has highest-popularity information.

In one embodiment, the terminal first determines, according to the download rate of the terminal, a bit rate that satisfies the download rate, and determines, according to popularity information, a download address corresponding to the video fragment that needs to be obtained by the terminal. Therefore, on the premise of satisfying the download rate of the terminal, there is a higher probability that the video fragment can be directly obtained from the cache server, and the cache server does not need to first obtain the video fragment from the source site and then send the video fragment to the terminal. This reduces a time for obtaining the video fragment by the terminal, and further, can reduce a delay of playing the video fragment.

At 303, the terminal determines, according to the download rate of the terminal, that sub-file information corresponding to a bit rate that satisfies the download rate of the terminal does not exist. In one embodiment, the terminal determines, according to the download rate of the terminal, that all bit rates corresponding to the video file are greater than the download rate of the terminal. That is, sub-file information corresponding to a bit rate that satisfies the download rate of the terminal does not exist.

For example, the download rate of the terminal is 900 kbps, and bit rates of the video file respectively are 1000 kbps, 1500 kbps, and 2000 kbps. All bit rates of the video file are greater than the download rate of the terminal. That is, sub-file information corresponding to a bit rate that satisfies the download rate of the terminal does not exist.

At 304, the terminal obtains, from the video index information, a download address of an N^{th} video fragment in sub-file information corresponding to a lowest bit rate. In one embodiment, if a bit rate that satisfies the download rate of the terminal does not exist, the terminal obtains, from the video index information, the download address of the N^{th} video fragment in the sub-file information corresponding to the lowest bit rate.

For example, the download rate of the terminal is 900 kbps, and bit rates of the video file respectively are 1000 kbps, 1500 kbps, and 2000 kbps. The terminal obtains, from the video index information, a download address of the N^{th} video fragment in sub-file information corresponding to the bit rate 1000 kbps.

In one embodiment, after determining that sub-file information corresponding to a bit rate that satisfies the download rate of the terminal does not exist, the terminal can select the download address of the N^{th} video fragment in the sub-file information corresponding to the lowest bit rate, thereby reducing a probability that frame freezing occurs in playing of the video fragment.

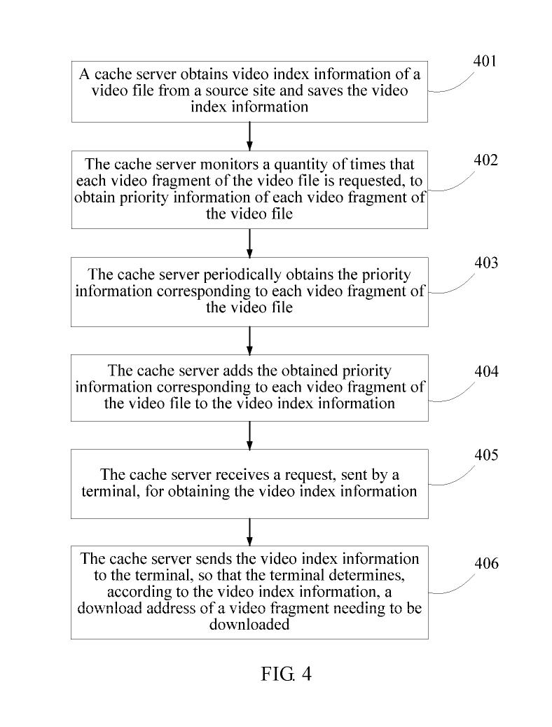

An embodiment of the invention provides another method of obtaining a video fragment. As shown in FIG. 4, the method includes the following steps.

At 401, a cache server obtains video index information of a video file from a source site and saves the video index information. In one embodiment, the video index information includes master file information and sub-file information.

In one embodiment, the cache server obtains video index information of each video fragment from the source site, and saves the video index information of each video fragment to a local cache of the cache server. In one embodiment, the cache server records a storage path of the video index information of the video file. The video index information is represented by using a URL of the video index information.

For example, as shown in Table 2 herein below, video index information is http://youku/test.m3u8, http://youku/test1500.m3u8, http://youku/test2500.m3u8, and http://youku/test3500.m3u8, and corresponding storage paths respectively are /youku/test.m3u8, /youku/test1500.m3u8, /youku/test2500.m3u8, and/youku/test3500.m3u8.

TABLE 2
Storage of video index information

| | Local storage path of video |
|---|---|
| URL of video index information | index information |
| http://youku/test.m3u8 | /youku/test.m3u8 |
| http://youku/test1000.m3u8 | /youku/test1000.m3u8 |
| http://youku/test1500.m3u8 | /youku/test1500.m3u8 |
| http://youku/test2000.m3u8 | /youku/test2000.m3u8 |

At 402, the cache server monitors a quantity of times that each video fragment of the video file is requested, to obtain priority information of each video fragment of the video file.

In one embodiment, the cache server monitors a quantity (or number) of times that each video fragment of the video file is requested in a preset period to obtain priority information of each video fragment of the video file. In one embodiment, the priority information may be popularity information. In one embodiment, the priority information of the video fragment is a quantity of times that the video fragment is requested or is obtained through conversion according to a preset rule and the quantity of times that the video fragment is requested.

For example, if a quantity of times that a video fragment is requested is 300, priority information of the video fragment is 300. Alternatively, a quantity 300 of times that a video fragment is requested may be converted according to a preset rule to obtain that priority information is 3. In one embodiment, the preset rule may be dividing the quantity of times that the video fragment is requested by 100, that is, DIV (the quantity of times that the video fragment is requested, 100).

At 403, the cache server periodically obtains the priority information corresponding to each video fragment of the video file. In one embodiment, the cache server obtains the priority information corresponding to each video fragment of the video file every hour, every half day, every other day, or any suitable frequency. This is not limited in this embodiment of the invention.

At 404, the cache server adds the obtained priority information corresponding to each video fragment of the video file to the video index information. In one embodiment, each video fragment has corresponding video index information. The cache server adds the obtained priority information corresponding to each video fragment of the video file to video index information corresponding to the video fragment.

In one embodiment, as shown in Table 3 herein below, the cache server stores, in a particular storage format, a local storage path and priority information of a video fragment, and information indicating whether the video fragment is locally cached.

TABLE 3
Storage of a video fragment

| | | | Whether |
|---|---|---|---|
| | | | a video |
| | | | fragment |
| | | Priority | is locally |
| URL of a video fragment | Local storage path | information | cached |
| http://youku/test1500/0.ts | /youku/test1500/0.ts | 100 | 1 |
| http://youku/test1500/1.ts | /youku/test1500/1.ts | 200 | 1 |
| http://youku/test1500/2.ts | /youku/test1500/2.ts | 5 | 0 |

“1” represents that a video fragment is locally stored, and “0” represents that a video fragment is not locally stored.

At 405, the cache server receives a request, sent by a terminal, for obtaining the video index information.

At 406, the cache server sends the video index information to the terminal, so that the terminal determines, according to the video index information, a download address of a video fragment needing to be downloaded.

It should be noted that in this embodiment of the invention, when the cache server receives the request sent by the terminal for obtaining the video index information, the cache server sends the master file information to the terminal. The terminal parses the master file information to obtain download addresses of all sub-file information. The cache server receives a request message carrying the download addresses of all the sub-file information, and sends all the sub-file information to the terminal, so that the terminal determines, according to the download rate of the terminal and priority information in the sub-file information, the download address of the video fragment that needs to be downloaded.

According to the method of obtaining a video fragment provided in this embodiment of the invention, compared with the conventional method in which a to-be-played video fragment is obtained, in one embodiment, a cache server monitors a quantity of times that each video fragment of a video file is requested to obtain priority information of each video fragment, adds the priority information of each video fragment to video index information, so that a terminal can determine, according to the priority information of the video fragment in the video index information, a probability that each video fragment is stored on the cache server, and preferably select a video fragment that is possibly locally cached on the cache server. This reduces a probability that the cache server obtains a video fragment from a source site, thereby reducing a time for obtaining a video fragment by the terminal, and further, reducing a delay of playing the video fragment.

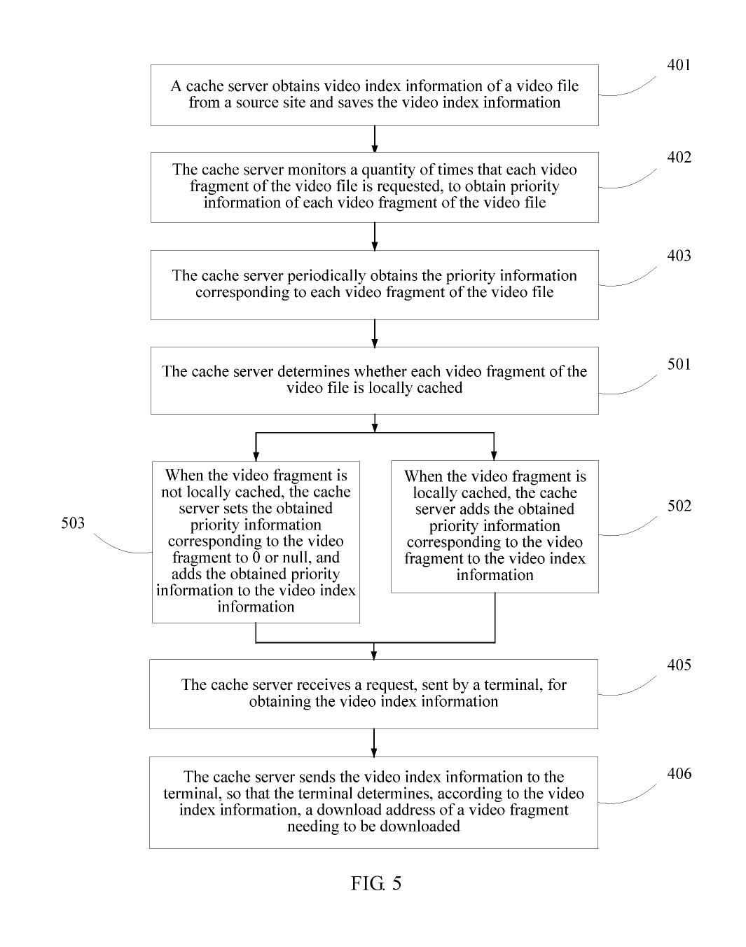

In some embodiments, based on the implementation shown in FIG. 4, before step 404 of adding, by the cache server, the obtained priority information corresponding to each video fragment of the video file to the video index information, the method may further include step 501 shown in FIG. 5. In some embodiments, step 404 of adding, by the cache server, the obtained priority information corresponding to each video fragment of the video file to the video index information may include step 502 or step 503 as shown in FIG. 5.

At 501, the cache server determines whether each video fragment of the video file is locally cached.

At 502, when or if the video fragment is locally cached, the cache server adds the obtained priority information corresponding to the video fragment to the video index information. For example, as shown in Table 3 above, local storage statuses of the video fragment http://youku/test1500/0.ts and the video fragment http://youku/test1500/1.ts are 1, which represents that the two video fragments are locally stored. Priority information corresponding to the two video fragments is respectively added to corresponding video index information.

At 503, when or if the video fragment is not locally cached, the cache server sets the obtained priority information corresponding to the video fragment to 0 or null, and adds the obtained priority information to the video index information. For example, as shown in

Table 3 above, a local storage status of the video fragment http://youku/test1500/2.ts is 0, which represents that the video fragment is not locally stored. Priority information corresponding to the video fragment is set to 0 or null, and then is added to video index information.

It should be noted that because the cache server receives requests from a large quantity of terminals all the time, priority information of video fragments in the cache server always changes. In one embodiment, the step of obtaining priority information of a video fragment and adding the priority information to video index information is performed periodically, for example, may be performed every morning when a traffic flow is relatively small. Therefore, when the terminal obtains video index information from the cache server at a moment, priority information included in the video index information of a video fragment may be inaccurate (because data is obtained in the morning of that day). This is the meaning of introducing priority information in this embodiment of the invention. Because the cache server has limited storage space, when space of the cache server is insufficient, a video fragment with low-priority information is preferably eliminated. High-priority information of a video fragment means a higher probability that the video fragment is still cached on the cache server for a time period in the future.

In one embodiment, a cache server determines whether a video fragment is locally cached to add priority information corresponding to the video fragment to corresponding video index information, or set priority information corresponding to the video fragment to 0 or null and add the priority information to corresponding video index information. This way, a terminal may determine, according to the priority information of the video fragment in the video index information, whether the video fragment is locally stored on the cache server, and on the premise that a download rate is satisfied, preferably select a video fragment that is possibly locally cached on the cache server. This reduces a probability that the cache server obtains a video fragment from a source site, thereby reducing a time for obtaining a video fragment by the terminal.

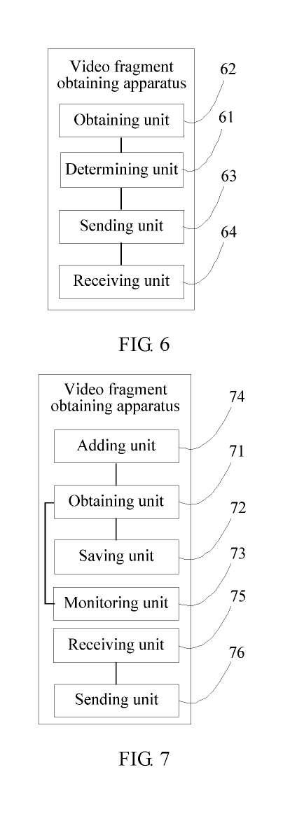

Further, to implement the methods shown in FIG. 2 and FIG. 3, an embodiment of the invention further provides an apparatus for obtaining a video fragment. The apparatus may be located in a terminal and is configured to reduce a delay of obtaining a video fragment. As shown in FIG. 6, the apparatus includes a determining unit 61, an obtaining unit 62, a sending unit 63, and a receiving unit 64.

The determining unit 61 is configured to determine, according to a trigger condition for obtaining a video fragment, that a video fragment needs to be obtained by the terminal is an N^{th} video fragment of a video file, where N is a positive integer.

In one embodiment, the trigger condition is when bit rate conversion information entered by a user is received, information indicating that frame freezing occurs in playing of the video file is received, or a touch operation of a user is received. In one embodiment, the touch operation includes a dragging operation.

The obtaining unit 62 is configured to obtain video index information of the video file from a cache server. In one embodiment, the video index information includes sub-file information corresponding to at least two bit rates, and sub-file information corresponding to each bit rate includes download addresses of different video fragments and corresponding priority information.

The priority information is used to represent a probability that a video fragment stored on the cache server is or has been eliminated. In one embodiment, the priority information includes popularity information. Higher-popularity information for example represents a smaller probability that a video fragment that is stored on the cache server and corresponds to the popularity information is or has been eliminated. When the popularity information is 0 or null, it represents that the cache server stores no video fragment corresponding to the popularity information.

In some embodiments, the determining unit 61 is further configured to determine a download address of the N^{th} video fragment according to a download rate of the terminal and the video index information that is obtained by the obtaining unit 62.

The sending unit 63 is configured to send a request message for obtaining a video fragment to the cache server. In one embodiment, the request message for obtaining a video fragment includes the download address of the N^{th} video fragment determined by the determining unit 61.

The receiving unit 64 is configured to receive the N^{th} video fragment returned by the cache server.

In one embodiment, the determining unit 61 is configured to determine, according to the download rate of the terminal, sub-file information corresponding to a bit rate satisfying the download rate of the terminal. In one embodiment, the determining unit 61 is further configured to obtain, from the sub-file information corresponding to the bit rate that satisfies the download rate of the terminal, a download address of an N^{th} video fragment in sub-file information that corresponds to the bit rate and in which the N^{th} video fragment has highest-popularity information.

In one embodiment, the determining unit 61 is further configured to determine, according to the download rate of the terminal, that sub-file information corresponding to a bit rate that satisfies the download rate of the terminal does not exist. In one embodiment, the determining unit 61 is further configured to obtain, from the video index information, a download address of an N^{th} video fragment in sub-file information corresponding to a lowest bit rate.

Compared with the conventional method in which to-be-played video fragment information is obtained, according to the video fragment obtaining apparatus provided in this embodiment of the invention, when the terminal needs to obtain an N^{th} video fragment of a video file, the terminal determines, as a request address according to priority information of N^{th} video fragments at different bit rates in video index information and a download rate of the terminal, a download address of an N^{th} video fragment that corresponds to highest-priority information and is at a bit rate satisfying the download rate of the terminal, to obtain the video fragment. According to the solution provided in this embodiment of the invention, a probability of an upstream operation of a cache server can be reduced, thereby reducing a time for obtaining a video fragment by a terminal, and further reducing a delay of playing the video fragment on the terminal.

Further, this embodiment of the invention provides another apparatus for obtaining a video fragment. The terminal first determines, according to a download rate of the terminal, a bit rate that satisfies the download rate, and determines, according to priority information, a download address corresponding to an N^{th} video fragment. Therefore, not only the download rate of the terminal can be satisfied, but also the N^{th} video fragment can be directly obtained from a cache server, and the cache server does not need to first obtain the N^{th} video fragment from a source site and then send the N^{th} video fragment to the terminal, thereby further reducing a delay of obtaining the video fragment.

Further, to implement the methods shown in FIG. 4 and FIG. 5, an embodiment of the invention provides another apparatus for obtaining a video fragment. The apparatus may be located in a cache server, and is configured to reduce a delay of playing a video fragment. As shown in FIG. 7, the apparatus includes an obtaining unit 71, a saving unit 72, a monitoring unit 73, an adding unit 74, a receiving unit 75, and a sending unit 76.

The obtaining unit 71 is configured to obtain video index information of a video file from a source site.

The saving unit 72 is configured to save the video index information of the video file.

The monitoring unit 73 is configured to monitor a quantity of times that each video fragment of the video file is requested to obtain priority information of each video fragment of the video file. In one embodiment, the priority information of the video fragment is a quantity (or number) of times that the video fragment is requested or is obtained through conversion according to a preset rule and the quantity of times that the video fragment is requested.

In one embodiment, the obtaining unit 71 is further configured to periodically obtain the priority information corresponding to each video fragment of the video file.

The adding unit 74 is configured to add the priority information obtained by the obtaining unit 71 corresponding to each video fragment of the video file to the video index information.

The receiving unit 75 is configured to receive a request sent by a terminal for obtaining the video index information.

The sending unit 76 is configured to send the video index information to the terminal, so that the terminal determines, according to the video index information, a download address of a video fragment needing to be downloaded.

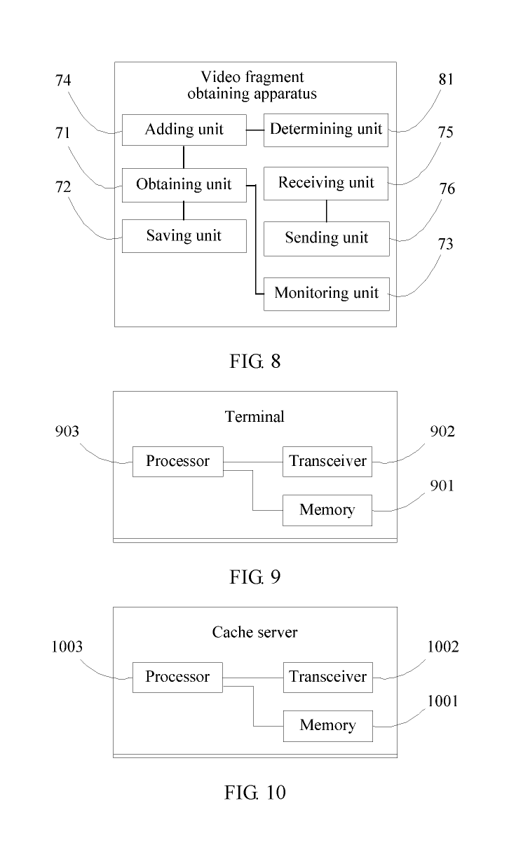

Further, as shown in FIG. 8, the apparatus further includes a determining unit 81. In one embodiment, the determining unit 81 is configured to determine whether each video fragment of the video file is locally cached.

In some embodiments, the adding unit 74 is configured to: when the determining unit 81 determines that the video fragment is locally cached, add the obtained priority information corresponding to the video fragment to the video index information, or when the determining unit 81 determines that the video fragment is not locally cached, set the obtained priority information corresponding to the video fragment to 0 or null, and add the obtained priority information to the video index information.

Compared with the conventional method in which to-be-played video fragment information is obtained, in this embodiment of the invention, the cache server monitors a quantity of times that each video fragment of a video file is requested to obtain priority information of each video fragment, adds the priority information of each video fragment to video index information so that a terminal can determine, according to the priority information of the video fragment in the video index information, a probability that each video fragment is stored on the cache server, and preferably select a video fragment that is possibly cached locally on the cache server. This reduces a probability that the cache server obtains a video fragment from a source site, thereby reducing a time for obtaining a video fragment by the terminal, and further reducing a delay of playing the video fragment.

Further, an embodiment of the invention provides another apparatus for obtaining a video fragment. The cache server determines whether a video fragment is locally cached to add priority information corresponding to the video fragment to corresponding video index information, or set priority information corresponding to the video fragment to 0 or null and add the priority information to corresponding video index information. This way, the terminal may determine, according to the priority information corresponding to the video fragment in the video index information, whether the video fragment is locally stored on the cache server, and on the premise that a download rate is satisfied, preferably select a video fragment that is locally stored on the cache server, thereby reducing a time for obtaining a video fragment by the terminal.

Still further, an embodiment of the invention provides a terminal. As shown in FIG. 9, the terminal includes a memory 901, a transceiver 902, and a processor 903. Both the memory 901 and the transceiver 902 are connected or coupled to the processor 903. The terminal is configured to execute the method implemented by the terminal in the embodiments shown in FIG. 2 and FIG. 3.

The memory 901 is configured to store computer executable program code. The program code includes instructions. The processor 903 executes the instructions, to instruct a network element to perform the following operations:

determining, according to a trigger condition for obtaining a video fragment, that a video fragment that needs to be obtained by the terminal is an N^{th} video fragment of a video file, where N is a positive integer;

obtaining video index information of the video file from a cache server, where the video index information includes sub-file information corresponding to at least two bit rates, and sub-file information corresponding to each bit rate includes download addresses of different video fragments and corresponding priority information;

determining a download address of the N^{th} video fragment according to a download rate of the terminal and the video index information;

sending a request message for obtaining a video fragment to the cache server, where the request message for obtaining a video fragment includes the download address of the N^{th} video fragment; and

receiving the N^{th} video fragment returned by the cache server.

Compared with the conventional method in which to-be-played video fragment information is obtained, according to the terminal provided in this embodiment of the invention, when the terminal needs to obtain an N^{th} video fragment of a video file, the terminal determines, as a request address according to priority information of N^{th} video fragments at different bit rates in video index information and a download rate of the terminal, a download address of an N^{th} video fragment that corresponds to highest-priority information and is at a bit rate satisfying the download rate of the terminal, to obtain the video fragment. According to the solution provided in the invention, a probability of an upstream operation of a cache server can be reduced, thereby reducing a time for obtaining a video fragment by the terminal, and further reducing a delay of playing the video fragment on the terminal.

Further, an embodiment of the invention provides a terminal. The terminal first determines, according to the download rate of the terminal, a bit rate that satisfies the download rate, and determines, according to priority information, a download address corresponding to an N^{th} video fragment. Therefore, not only the download rate of the terminal can be satisfied, but also the N^{th} video fragment can be directly obtained from the cache server, and the cache server does not need to first obtain the N^{th} video fragment from a source site and then send the N^{th} video fragment to the terminal, thereby reducing a delay of obtaining the video fragment.

Still further, an embodiment of the invention further provides a cache server. As shown in FIG. 10, the cache server includes a memory 1001, a transceiver 1002, and a processor 1003. Both the transceiver 1002 and the memory 1001 are connected or coupled to the processor 1003. The cache server is configured to execute the authentication method implemented by the cache server in the embodiments shown in FIG. 4 and FIG. 5.

The memory 1001 is configured to store computer executable program code. The program code includes instructions. The processor executes the instructions, to instruct a network element to perform the following operations:

obtaining video index information of a video file from a source site and saving the video index information;

monitoring a quantity of times that each video fragment of the video file is requested to obtain priority information of each video fragment of the video file;

periodically obtaining the priority information corresponding to each video fragment of the video file, and adding the obtained priority information corresponding to each video fragment of the video file to the video index information;

receiving a request, sent by a terminal, for obtaining the video index information; and

sending the video index information to the terminal so that the terminal determines, according to the video index information, a download address of a video fragment needing to be downloaded.

Compared with the conventional method in which to-be-played video fragment information is obtained, in this embodiment of the invention, the cache server monitors a quantity of times that each video fragment of a video file is requested to obtain priority information of each video fragment, adds the priority information of each video fragment to video index information so that a terminal can determine, according to the priority information of the video fragment in the video index information, a probability that each video fragment is stored on the cache server, and preferably select a video fragment that is possibly locally cached on the cache server. This reduces a probability that the cache server obtains a video fragment from a source site, thereby reducing a time for obtaining a video fragment by the terminal, and further reducing a delay of playing the video fragment.

It should be noted that for other descriptions corresponding to the units of the apparatus for obtaining the video fragment provided in the embodiments of the invention, refer to the corresponding descriptions in FIG. 2, FIG. 3, FIG. 4, and FIG. 5. Details are not described herein again for brevity sake.

The apparatus for obtaining a video fragment provided in the embodiments of the invention can implement the method embodiments provided above. For specific functional implementation, refer to the descriptions in the method embodiments. Details are not described herein again. The method and apparatus for obtaining a video fragment provided in the embodiments of the invention may be applicable to, but not limited to, a scenario in which a terminal directly obtains, from a cache server, a video fragment needing to be obtained, and plays the video fragment.

A person of ordinary skill in the art may understand that all or some of the processes of the methods in the embodiments may be implemented by a computer program instructing relevant hardware. The program may be stored in a computer or machine readable storage medium. When the program runs, the processes of the methods in the embodiments are performed. The foregoing storage medium may include: a magnetic disk, an optical disc, a read-only memory (ROM), or a random access memory (RAM).

The foregoing descriptions are merely specific embodiments of the invention, but are not intended to limit the protection scope of the invention. Any variation or replacement readily figured out by a person skilled in the art within the technical scope disclosed in the present invention shall fall within the protection scope of the invention. Therefore, the protection scope of the invention shall be subject to the protection scope of the claims.

What is claimed is:

1. A method of obtaining a video fragment of a video file, the method comprising:
in response to a trigger condition for obtaining a video fragment, determining, by a terminal, that the video fragment needs to be obtained is a numbered video fragment of the video file;
obtaining, by the terminal, video index information of the video file from a cache server, wherein the video index information comprises sub-file information corresponding to at least two bit rates, wherein each sub-file information corresponding to each of the at least two bit rates comprises download addresses of different video fragments at the bit rate and corresponding priority information;
determining, by the terminal, a download address of the numbered video fragment from the download addresses of different video fragments according to a download rate of the terminal and the video index information;
sending, by the terminal, a request message for obtaining the numbered video fragment to the cache server, wherein the request message comprises the download address of the numbered video fragment; and
receiving, by the terminal, the numbered video fragment returned by the cache server.

2. The method according to claim 1, wherein the trigger condition is:
a touch operation of a user is received, wherein the touch operation comprises a dragging operation.

3. The method according to claim 1, wherein the priority information is used to represent a probability that a video fragment stored on the cache server has been eliminated.

4. The method according to claim 3, wherein the priority information comprises popularity information, wherein higher-popularity information represents a smaller probability that a video fragment that is stored on the cache server and corresponds to the popularity information has been eliminated.

5. The method according to claim 4, wherein when the popularity information is 0 or null, it represents that the cache server stores no video fragment corresponding to the popularity information.

6. The method according to claim 4, wherein determining a download address of the numbered video fragment from the download addresses of different video fragments according to a download rate of the terminal and the video index information comprises:
determining, by the terminal, according to the download rate of the terminal, sub-file information corresponding to a bit rate satisfying the download rate of the terminal, and obtaining by the processor of the terminal, from the sub-file information corresponding to the bit rate satisfying the download rate of the terminal, a download address of a numbered video fragment in the sub-file information that corresponds to the bit rate and in which the numbered video fragment has highest-popularity information; or
determining, by the terminal, according to the download rate of the terminal, that sub-file information corresponding to a bit rate satisfying the download rate of the terminal does not exist; and obtaining by the processor of the terminal, from the video index information, a download address of a numbered video fragment in the sub-file information corresponding to a lowest bit rate.

7. A method of obtaining a video fragment of a video file, the method comprising:
obtaining, by a cache server, video index information of a video file from a source site and saving the video index information;
monitoring, by the cache server, a quantity of times that each video fragment of the video file is requested to obtain priority information of each video fragment of the video file;
periodically obtaining, by the cache server, the priority information corresponding to each video fragment of the video file, and adding the obtained priority information corresponding to each video fragment of the video file to the video index information;
receiving, by the cache server, a request from a terminal for obtaining the video index information; and
sending, by the cache server, the video index information to the terminal so that the terminal determines, according to the video index information, a download address of a video fragment needing to be downloaded.

8. The method according to claim 7, wherein the priority information of the video fragment is a quantity of times that the video fragment is requested, or obtained through a conversion according to a preset rule and the quantity of times that the video fragment is requested.

9. The method according to claim 7, further comprising: prior to adding the obtained priority information corresponding to each video fragment of the video file to the video index information,
determining by, the cache server, whether each video fragment of the video file is locally cached,
if the video fragment is locally cached, adding, by the cache server, the obtained priority information corresponding to the video fragment to the video index information, and
otherwise, if the video fragment is not locally cached, setting, by the cache server, the obtained priority information corresponding to the video fragment to 0 or null, and adding the obtained priority information to the video index information.

10. An apparatus for obtaining a video fragment, the apparatus being included in a terminal, the apparatus comprising:
a processor;
a transceiver coupled to the processor; and
a memory coupled to the processor to store instructions, which when executed by the processor, cause the apparatus to perform operations, the operations including:
in response to a trigger condition for obtaining a video fragment, determining that the video fragment needing to be obtained by the terminal is a numbered video fragment of a video file;
obtaining video index information of the video file from a cache server, wherein the video index information comprises sub-file information corresponding to at least two bit rates, wherein each sub-file information corresponding to each of the at least two bit rates comprises download addresses of different video fragments at the bit rate and corresponding priority information,
determining a download address of the numbered video fragment from the download addresses of different video fragments according to a download rate of the terminal and the video index information;
sending a request message for obtaining the numbered video fragment to the cache server, wherein the request message comprises the download address of the numbered video fragment; and
receiving the numbered video fragment returned by the cache server.

11. The apparatus according to claim 10, wherein the trigger condition is:
a touch operation of a user is received, wherein the touch operation comprises a dragging operation.

12. The apparatus according to claim 10, wherein the priority information is used to represent a probability that a video fragment stored on the cache server has been eliminated.

13. The apparatus according to claim 12, wherein the priority information comprises popularity information, wherein higher-popularity information represents a smaller probability that a video fragment that is stored on the cache server and corresponds to the popularity information has been eliminated.

14. The apparatus according to claim 13, wherein when the popularity information is 0 or null, it represents that the cache server stores no video fragment corresponding to the popularity information.

15. The apparatus according to claim 13, wherein determining a download address of the numbered video fragment comprises:
determining, according to the download rate of the terminal, sub-file information corresponding to a bit rate satisfying the download rate of the terminal, and obtaining, from the sub-file information corresponding to the bit rate satisfying the download rate of the terminal, a download address of a numbered video fragment in the sub-file information that corresponds to the bit rate and in which the numbered video fragment has highest-popularity information; or
determining, according to the download rate of the terminal, that sub-file information corresponding to a bit rate satisfying the download rate of the terminal does not exist, and obtaining, from the video index information, a download address of a numbered video fragment in the sub-file information corresponding to a lowest bit rate.

16. An apparatus for obtaining a video fragment, the apparatus being included in a cache server, the apparatus comprising:
a processor;
a transceiver coupled to the processor; and
a memory coupled to the processor to store instructions, which when executed by the processor, cause the apparatus to perform operations, the operations including:
obtaining video index information of a video file from a source site;
saving the video index information of the video file;
monitoring a quantity of times that each video fragment of the video file is requested to obtain priority information of each video fragment of the video file;
periodically obtaining the priority information corresponding to each video fragment of the video file, and adding the priority information corresponding to each video fragment of the video file to the video index information;
receiving a request from a terminal for obtaining the video index information; and
sending the video index information to the terminal, so that the terminal determines, according to the video index information, a download address of a video fragment needing to be downloaded.

17. The apparatus according to claim 16, wherein the priority information of the video fragment is a quantity of times that the video fragment is requested, or obtained through a conversion according to a preset rule and the quantity of times that the video fragment is requested.

18. The apparatus according to claim 16, wherein the operations further include:
determining whether each video fragment of the video file is locally cached,
if the video fragment is locally cached, adding the obtained priority information corresponding to the video fragment to the video index information, and
otherwise, if the video fragment is not locally cached, setting the obtained priority information corresponding to the video fragment to 0 or null, and adding the obtained priority information to the video index information.

19. A non-transitory computer-readable medium comprising instructions stored therein, which when executed by a computer, cause the computer to perform the method of claim 1.

20. A non-transitory computer-readable medium comprising instructions stored therein, which when executed by a computer, cause the computer to perform the method of claim 7.
